(19) United States
(12) Patent Application Publication
(10) Pub. No.: US 2019/0232751 A1
(43) Pub. Date: Aug. 1, 2019

(54) Cool Fuel Line

(71) Applicant: Demetrice Quinn, Morrisville, NC (US)

(72) Inventor: Demetrice Quinn, Morrisville, NC (US)

(21) Appl. No.: 15/883,602

(22) Filed: Jan. 30, 2018

(51) Int. Cl. B60H 1/00; F02M 31/20

(52) U.S. Cl. CPC B60H 1/00271; B60H 2001/00307; F02M 31/205

(57) ABSTRACT

Apparatus for regulating, monitoring and changing the temperature of fluids generally comprise a first line configured to have an inlet end and an outlet end. The first line directly surrounded by a second line wherein a third line is coupled to the outer surface of the second line. The first line coupled to a plurality of temperature switches to regulate the temperature flow of the liquids coming in and out of the first line. A plurality of line adapters coupled to the outlet of line second and third line.

### BACKGROUND OF INVENTION

### Field of Invention

The present invention relates in general to system for regulating a plurality of different fluids temperatures in a vehicle.

### Description of Related Art

In the past a device for cooling the fuel line before the throttle, fuel injection system or carburetor of engine. This particular device included a fire resistant wrap with pockets for holding a frozen material, such as an ice pack, gel pack, or ice. In another device one or more element described a cooling fuel engine system with a common rail fuel injection system having a coolant pump and a fan.

### SUMMARY OF THE INVENTION

In various representative aspects, the present invention includes a system for regulating fluids temperature in a vehicle may include a first line, a fuel line, a fuel injection, a pistol head gas coupled to the fuel injection, an inlet temperature switch, and an outlet temperature measuring switch coupled to the first line. A second line may be directly coupled inside the first line, a cut switch, a third line coupled the outer surface of the first line wherein the third line separates into a fourth line, and a plurality of cool flow line adaptors. According to some example embodiments, the system may regulate liquids like gas, oil, or other forms of liquids threw a cool flow line system.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a system for regulating fluids.

FIG. 2 representatively illustrates a plurality of lines.

FIG. 3 representatively illustrates a distal end of a system.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

### Intro

Some detailed example embodiments are disclosed herein. However, specific structural and functional details disclosed herein are merely representative for purposes of describing examples embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalent, and alternatives falling within the scope of example embodiments. Like numbers refer to like elements throughout the description of the figures.

It should be understood that when an element or layer is referred to as being “on”, “connected to”, “coupled to”, or “covering” another element or layer, it may be directly on, connected to, coupled to, or covering the other elements or layer or intervening elements or layers may be present. In contrast, when an element is referred to as being “directly on”, “directly connected to”, or “directed coupled to” another element or layer, there are no intervening elements or layer present. Like numbers refer to like elements throughout the specification. As used herein, the term “and/or” includes any and all combinations of one or more of the associated listed items.

It should be understood that, although the terms first, second, third, etc. may be used herein to describe various elements, regions, layer and/or sections, these elements, regions, layers, and/or section should not be limited by these terms. These terms are only used to distinguish one element, region, layer, or section discussed below could be termed a second element, region, layer, or section without departing from the teaching embodiments.

Spatially relative terms (e.g., “beneath”, “below”, “lower”, “above”, “upper”, and the like) may be used herein for ease of description to describe one element or feature's relationship to another element(s) or feature(s) as illustrated in figures. It should be understood that the spatially relative terms are intended to encompass different orientations of the device in use or operation in addition to the orientation depicted in the figures. For example, if the device in the figures is turned over, elements describe as “below” or “beneath” other elements or features would then be oriented “above” the other elements or features. Thus, the term “below” may encompass both an orientation of above and below. The device may be otherwise oriented (rotated 90 degree or at other orientations) and the spatially relative descriptors used herein interpreted accordingly.

The terminology used herein is for the purpose of describing various example embodiments only and is not intended to be limiting of example embodiments. As used herein, the singular forms “a”, “an”, and “the” are intended to include the plural forms as well, unless the context clearly indicates otherwise. It will be further understood that the terms “includes”, “including”, “comprises”, and/or “comprising” when used in this specification, specify the presence of stated features, integers, steps, operations, and/or elements, but do not preclude the presence or addition of one or more other features, integers, steps, operations, elements, and/or groups thereof.

Example embodiments are described herein with reference to cross-sectional illustrations that are schematic illustration of idealized embodiments (and intermediate structures) of example embodiments. As such, variations from the shapes of the illustration as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

### General

Various representative implementations of the present invention may be applied to any system for regulating in-line fluids temperature in vehicles, motorcycles, airplanes, or boats. Certain representative implementations may include, for example: the in-line fluid such as but limited to gas, oil, fuels, or liquids.

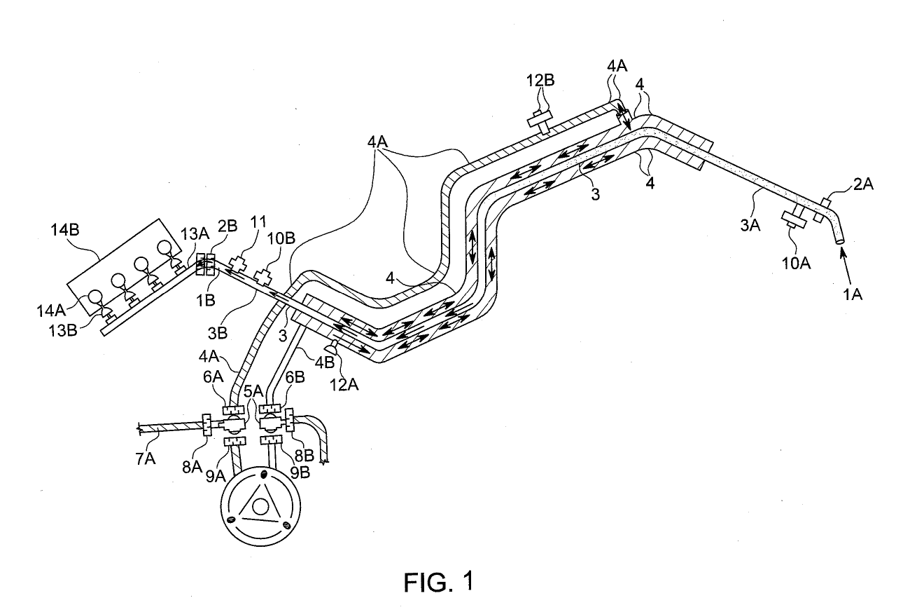

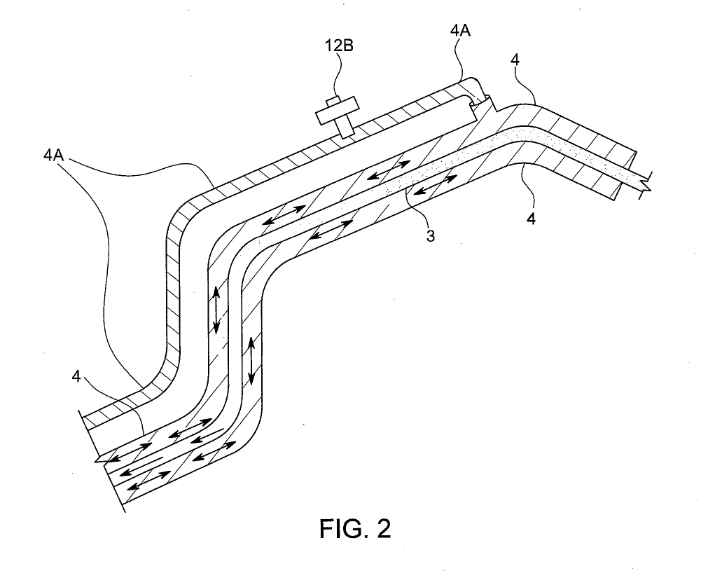

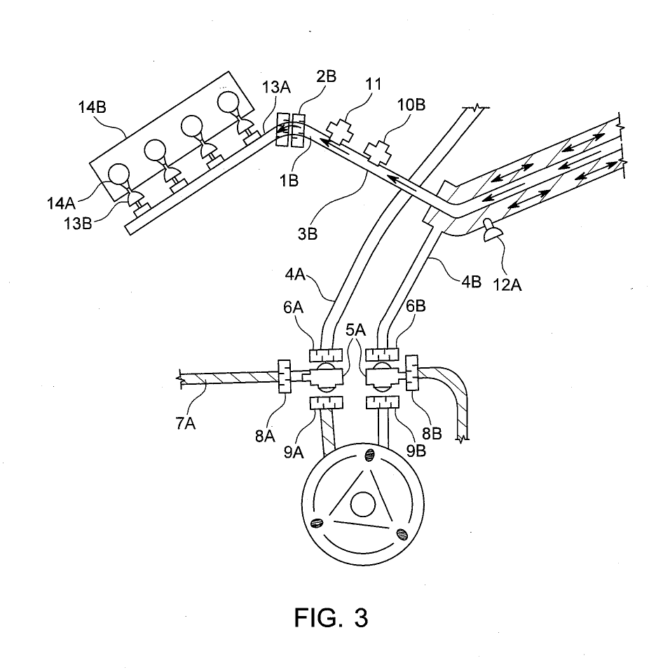

FIG. 1 is a perspective view of a system regulating fluids including an engine, a plurality of lines, a plurality of sensors, and an Air Conditioning Unit (A/C). FIG. 2 representatively illustrates a plurality of lines. FIG. 3 representatively illustrates a distal end of a system.

### Structure

FIG. 1 representatively illustrates the system for regulating fluids including FIG. 2 and FIG. 3 according to some embodiments, the system for regulating fluids temperature, comprising: a first line 1A configured to have a proximal end and a distal end; a fuel line 13A coupled to the distal end of the first line 1A; a fuel injection 13B; a pistol head gas coupled to the fuel injection 13B; an inlet temperature switch coupled to the first line; an outlet temperature measuring switch coupled to the first line 3A; a second line 4A directly coupled inside the first line 3A; a cut off switch 11 coupled to the distal end of the first line 3A; a third line 4 coupled the outer surface of the first line 3A wherein the third line 4 separates into a fourth line; and a plurality of cool flow line adapters.

The system starts in the first line 3A, when liquid, gas, oil or any other type of fluids needs to be cooled down. The first line 3A may be connected to a plurality of different lines but a line may be connected to a cooling connector 2A when a liquid needs to be cooled down. For example a gas line may be connected to the cooling connector 2A when a gas line needs to be cool. The cooling connector 2A may also be connected to an oil line when cooling the temperature of oil. In addition it may connect to a transmission line when cooling down the transmission fluid for better operation. The cooling connector 2A is designed to connect to various types of lines such as but limited to gas, oil, fuel fluids and many other forms of liquids which may reach a warm or hot temperature that ultimately operates and performs better at cooler temperature. The inlet portion of the first line 1A is the primary inlet line for these various fluids to enter. These plurality of lines may be made of materials such as but limited to cooper, steel stainless steel, or aluminum.

Referring to FIG. 1 the first line 3A is coupled to a temperature sensor 10A that reads the temperature of the liquids entering into the system.

FIG. 2 representatively illustrates a plurality of lines. As depicted in FIG. 1 and FIG. 2 the first line 3 in the surrounded by an outer line referred to as the second line 4. The outer line coupled to the first line 3 near the distal end of the first line 3. The second line 4 may have a opening on the top of the outer line 4 wherein a third line 4A is inserted into the outer second line 4. As depicted the third line 4A is the second outer line 4 outlet were a low-side Freon gas outlet may travel through. An outer line cooling temperature reader 12B is coupled to the third line 4A outer surface.

FIG. 3 is representatively illustrates a distal end of a system. Referring to FIG. 3 the liquid travels through the first line 3A wherein the distal portion of the first line 3A is coupled to the outlet temperature measuring switch 10B. The outlet temperature measuring switch may be used for measuring in and out temperatures in the insides of the first line 3A. A cut off switch 11 is couple to the distal portion of the first line 3A. At the end of the first line 3A the line may be coupled to operate and perform more efficiently with hot liquids, coupling fuel rail 13A. The fuel rail 13A is connected to a plurality of fuel injections 13B which may simulate the engine pistons 14A which is an optional connection. The engine pistons 14A may be configured to have a shape such as but not limited to a cylinder, circular, or square shape.

As depicted the third line 4A is the second outer line 4 outlet were a low-side Freon gas outlet may travel through. Both the second outer line 4 and/or the third line 4A distal ends couple to a line adapter that may allow the line system low-side Freon gas 6B or low-side Freon liquid 6A to connect to the line or a vehicles A/C unit without disrupting the vehicle A/C system. 7A, 8A, and 9A connect the vehicle low-side Freon gas into the third line 4A outlet side. In another embodiment, 6B, 8B, and 9B connect the vehicle low-side liquid Freon into the third line 4B inlet side.

The system may be used in a case where gas is hot and begins to build up Vapors into one's engine may be the liquid in vapors going into the cylinder head but with the regulating line system it will keep the gas from getting hot so it goes to the engine as a liquid.

### Operation

The first line 1A is the inlet end also referred to as a Cool Flow Line wherein gas, oils, or any other form of liquid enters the Cool Flow Line and travel through 3A to 3 and finally reaching the first line outlet end 1B. First, a warm or hot liquid such as a gas, oil or fluid which warms up in the process of natural operation enters the inlet side 1A of the first line 3A. Next the warm or hot liquid pass inside the second outlet line 4. The second outer line 4 has a cool liquid Freon circulating inside which is designed to drop the temperature in the first line. A benefit of the temperature drop may allow the engine to run more efficient given the vehicle more horsepower and better emissions.

(Option 1) The first line outlet end 1B where potential gas may enter the fuel rail 13A. The vehicle engine 14B comprising a plurality of pistol cylinders 14A coupled between a plurality of fuel injections 13B and a fuel rail 13A. This optional attachment may connect to a car engine to cool down the gas going into the engine for better performance, emissions more horsepower or to a transmission from overheating and slipping. One benefit of this attachment may help last transmission fluid life last longer. Another embodiment of this attachment may connect to the engine oil to keep the engine oil temperature cooler which may keep all the internal engine parts cooler for better performance and longevity.
(Option 2) The second outer line couples to a Freon temperature sensor 12A to measure the second line inlet and outlet of the first line 3 system. Followed by an optional step, the outer second line 4 directly connected to an inlet side 4B which may connect to a high side freshen liquid Freon to warm up the first line 3 while operating any gas, oil, fluids or other liquids which may be operating in extreme cold conditions which may operate better at warmer temperatures

The fuel injection is another optional attachment mainly because the first line 3 is designed to cool down any type of liquid which operates better at cooler temperatures. The liquid gas Freon inside the inlet first line 3 which is the second line may have the liquid come out of the outlet side and the inner Freon low side gas and circulate back to the A/C unit.

The system for regulating in-line fluids such as but not limited to gas, oil, and fuels temperatures. For example a combustion engine in an airplane motor using, transmission, gas, oil, fuels, fluids and other forms of liquids that may get warm or hot during normal operations can now be cooled down.

### Closing

In the foregoing specification, the invention has been described with reference to specific exemplary embodiments. Various modifications and changes may be made, however, without departing from the scope of the present invention as set forth in the claims. The specification and figures are illustrative, not restrictive, and modifications are intended to be included within the scope of the present invention. Accordingly, the scope of the invention should be determined by the claims and their legal equivalents rather than by merely the examples described.

I claim:

1. A system for regulating fluids temperature in a vehicle, comprising:
a first line configured to have an inlet end and an outlet end;
a fuel line coupled to the outlet end of the first line;
a fuel injection coupled to the fuel line;
a pistol head gas coupled to the fuel injection;
an inlet temperature switch coupled to the first line;
an outlet temperature measuring switch coupled to the first line;
the first line directly surrounded by a second line;
a cut off switch coupled to the distal end of the first line;
a third line coupled the outer surface of the second line; and
a plurality of line adapters.

2. The system for regulating fluids temperature of claim 1, further comprising a cooling connector coupled near the first line inlet end.

3. The system for regulating fluids temperature of claim 1, further comprising a temperature sensor reader coupled near the first line inlet end.

4. The system for regulating fluids temperature of claim 1, further comprising the first line outlet end coupled to the fuel rail, wherein the fuel injections is coupled between the fuel rail and an engine pistons.

5. The system for regulating fluids temperature of claim 1, further comprising the pistol head gas configured to have a cylinder, circular, or square shape.

6. The system for regulating fluids temperature of claim 1, further comprising the pistol head gas is configured to connect to a vehicle engine, emissions or transmission.

7. The system for regulating fluids temperature of claim 1, further comprising the outlet temperature measuring switch configured to measure the temperature of the first line.

8. The system for regulating fluids temperature of claim 1, further comprising the second line configured to a have low side Freon gas wherein Freon gas temperature is being monitored.

9. The system for regulating fluids temperature of claim 1, further comprising the third line having a lower side wherein liquid Freon enters to cool the temperature of the liquid Freon.

10. The system for regulating fluids temperature of claim 1, further comprising the third line coupled the outer surface of the second line wherein a cool temperature reader is located on the outer surface.

11. The system for regulating fluids temperature of claim 1, further comprising the cool flow line adapter coupled between the second line, a vehicle low-side Freon gas side, and a vehicle Air Conditioning unit.

12. The system for regulating fluids temperature of claim 1, further comprising the cool flow line adapter coupled between the third line, the vehicle low-side Freon liquid, and the vehicle Air Conditioning unit.
